(19) United States
(12) Patent Application Publication
(10) Pub. No.: US 2023/0049516 A1
(43) Pub. Date: Feb. 16, 2023

(54) MIXED JET FLOW FIRE EXTINGUISHING SYSTEM

(71) Applicant: SHANDONG HAOXING JIESHI NEW MATERIAL TECHNOLOGY CO., LTD., Shandong (CN)

(72) Inventors: Zhiliang YANG, Shandong (CN); Yang YANG, Shandong (CN); Hao YANG, Shandong (CN); Tingyu MA, Shandong (CN); Meiqin YAO, Shandong (CN); Jinshui YAO, Shandong (CN)

(73) Assignee: SHANDONG HAOXING JIESHI NEW MATERIAL TECHNOLOGY CO., LTD., Shandong (CN)

(21) Appl. No.: 17/793,658

(22) PCT Filed: Jan. 17, 2021
(86) PCT No.: PCT/CN2021/072355

§ 371 Date: Jul. 19, 2022

(30) Foreign Application Priority Data
Jan. 19, 2020 (CN) 202010062351.0

(51) Int. Cl. B05B 7/08; A62C 99/00

(52) U.S. Cl. CPC B05B 7/0807; A62C 99/0072; A62C 99/0045

(57) ABSTRACT

Disclosed is a mixed jet flow fire extinguishing system, including a water spray nozzle and a powder spray nozzle. A water spray port of the water spray nozzle and a powder spray port of the powder spray nozzle do not overlap; super absorbent resin powder sprayed from the powder spray nozzle is externally mixed in the air with a water flow sprayed from the water spray nozzle. A powder spray direction A of the powder spray nozzle is inclined relative to a water flow spray direction B of the water spray nozzle. The technical bottleneck of using sodium polyacrylate resin powder as a fire extinguishing agent in the prior art is solved, so that the sodium polyacrylate resin powder can be smoothly and continuously sprayed into a fire, without blocking the powder spray port.

### BACKGROUND

### Technical Field

The present disclosure relates to the technology field of fire extinguishing equipment and, in particular, to a fire extinguishing system capable of forming a mixed jet flow of fire extinguishing resin powder and water, and a mixing method of a super absorbent resin powder fire extinguishing agent and water.

### Description of Related Art

So far, water is still the most commonly used fire extinguishing agent, with the advantages of being cheap and easy to obtain, and non-polluting to the environment. However, due to the good fluidity of water, most of the water will be lost after being sprayed into the fire, resulting in waste. Moreover, for large-scale fires with large fire area, rapid fire development, easy re-ignition, and difficulty in fighting, water fighting can often only control the spread of the fire, and it is difficult to put out the fire in a timely and effective manner. For the fire extinguishing agents that are widely used now, although the fire extinguishing effect has been improved, they are not effective for certain types of fires, and the residues cause serious environmental pollution.

Super absorbent resin (Super Absorbent Resin, SAR) is a new type of functional polymer material containing strong hydrophilic groups such as carboxyl and amide groups and having a certain degree of cross-linking, in water swellable and three-dimensional network structure. It is insoluble in both water and organic solvents, and has unique properties: strong water absorption and water retention. Compared with traditional water absorbent materials such as sponge, cotton, cellulose and silica gel, the super absorbent resin has a large water absorption capacity, can rapidly absorb liquid water that is dozens or even thousands of times its own weight, and has strong water retention. Furthermore, it is not easy to lose water even when being heated and under pressure, and at the same time has some characteristics of polymer materials. Due to these characteristics, the research and development of the super absorbent resin is extremely rapid, and it has been widely used in many fields such as agriculture, forestry, horticulture, medical and health, food industry, petrochemical industry, building materials and so on.

Super absorbent resin is developing rapidly, with a wide variety of types and many classification methods. It is mainly classified according to sources of raw materials, hydrophilization methods, types of hydrophilic groups, crosslinking methods and product form. The most commonly used classification method is according to sources of raw materials, classifying it into starch-based super absorbent resin, cellulose-based super absorbent resin, synthetic super absorbent resin, protein-based super absorbent resin, blended and composite super absorbent resin, etc.

The reason why the super absorbent resin can absorb water hundreds or even thousands of times its own weight is that it has two conditions: one is that it has hydrophilic groups such as carboxyl, hydroxyl, amide and sulfonic acid groups, making water absorption become possible; the other is that it has a three-dimensional spatial network structure and is insoluble in water, making water absorption a reality. The super absorbent resin is a three-dimensional network polymer with hydrophilic groups and light cross-linking. It can absorb a large amount of water and swell while keeping water from flowing out, and has the advantages of high water absorption rate, fast water absorption rate and strong water retention performance.

The application of the super absorbent resin, especially polymer hydrogel of polyacrylic acid-based super absorbent resin, in the field of fire extinguishing has the following advantages:

1. In the super absorbent resin, side groups of polymer electrolyte ionize to give corresponding anionic hydrophilic groups and cations (movable ions) when they meet with water. On the main chain network backbone are all negatively charged anions, which cannot move and have repulsive effect among them, generating the impetus for network expansion. Although the cations have certain mobility, they exist in the network due to the attraction and binding of opposite charges of the network backbone. Therefore, a concentration of cations inside the network is greater than a concentration of cations in the external water, and the ions generate osmotic pressure between inside and outside of the network, and in addition, the polyelectrolyte itself has strong hydrophilic groups. In this way, a large amount of water can enter the three-dimensional network in a short time. Under high temperature conditions, the super absorbent resin with a large amount of free water immobilized therein has a considerable heat capacity, and can consume a large amount of heat when it loses water, forming an effective isolation of the heat source, which is beneficial to the control of the fire. At the same time, spraying the super absorbent resin on objects near a fire source can play an effective role in isolation and protection.

2. The super absorbent resin forms an elastic gel after absorbing water, and particles of the gel are tightly connected, and there is no space for air to enter therebetween. Thus, the contact between the fire source with air can be isolated in the state of hydrogel, preventing the re-ignition of the dark fire, and protecting the objects that have been covered by the gel in a fire site, and thereby achieving the effect of rapid fire extinguishing.

3. The super absorbent resin forms a gel after absorbing water, which has excellent chemical stability, thermal stability and compatibility, and has a very high viscosity and good adhesion ability. After being sprayed on a vertical surface, it can cover on a surface of an object without falling down and form a sufficient adhesion thickness, which can effectively improve the fire prevention effectiveness of unburned objects in a fire site

4. The super absorbent resin-based polymer powders are safe in storage and transportation, with storage (airtight and waterproof) stability of more than two years, and are non-toxic; in strong fire, the resin burns into carbon dioxide and water after being heated and losing water, which are non-toxic to humans and animals; after the fire is extinguished, the residual resin in the fire site will be naturally degraded within a few months, which is non-toxic and pollution-free to humans and the environment, and is environmentally friendly.

5. The super absorbent resin powder has a light specific gravity and strong water absorption capacity. It can absorb water 300 or more times its own weight in a very short time. A resin powder content in an entire water-absorbing gel is generally between 0.05 and 0.5% by weight of water, and more generally about 0.1%. A large amount of fire extinguishing gel can be formed only with a small amount of the super absorbent resin powder, which has excellent fire extinguishing effect and can continuously absorb water, avoiding secondary damage caused by excess water flowing around, and having a water-saving effect.

6. The water-absorbing gel is weakly acidic, weakly alkaline or neutral, and does not corrode fire extinguishing equipment.

In the prior art, there is a technology of using acrylic polymer to prepare gel for fire extinguishing. For example, Chinese Patent CN107497088A discloses a hydrogel fire extinguishing agent and its application method, where the use method of the hydrogel fire extinguishing agent is dissolving the hydrogel fire extinguishing agent in water, and stirring for not more than 1 minute, to prepare a solution with a mass concentration of 3-5%, which solution can be used for fire extinguishing. CN107789085A discloses a new type of polymer gel water-based fire extinguishing agent, and in use, the new type of environmentally friendly polymer gel water-based fire extinguishing agent is added into 600-1000 times the mass of water, and is stirred for 3-5 minutes to form a polymer gel for fire extinguishing. CN207101696U discloses a new type of environmentally friendly fire extinguishing vehicle, where firstly, a material is put into a storage tank for a polymer fire extinguishing material, the fire extinguishing material enters a pipeline of a fire extinguishing cannon, and water comes out of a water tank and enters the pipeline of the fire extinguishing cannon through a fire pump water inlet, and then the water and the polymer material are fully mixed in the spiral pipeline under the action of a rotating mixing device, and then sprayed out from the fire extinguishing water cannon. CN100444912C discloses an application of a super absorbent resin water-absorbing gel fire extinguishing agent, where synthetic resin sodium polyacrylate is mixed with 1000 times of water, to form a water-absorbing gel in half an hour, and the gel can be sprayed into the fire with a water gun, and mixing fine powders of sodium polyacrylate with 1000 times of water and spraying to the fire site together from the spray gun can form a gel within 15 to 60 seconds, to extinguish the fire.

However, these super absorbent resin fire extinguishing agents all have major drawbacks in their using method. The inventor found through long-term experiments that the super absorbent resin powders will swell rapidly after absorbing water, and with the increase of water absorption, the viscosity thereof becomes higher and higher, until they are finally close to a solidified state, and the resin after stirring is very viscous and is easy to solidify, and it is difficult to find a suitable way to launch the nearly solid gel-like water-absorbing resin, precisely, spraying it out instead of throwing them out in clumps by humans or machines. Furthermore, during swelling, the resin will seriously block the pipelines of the fire extinguishing equipment, resulting in a discontinuous spraying, and even equipment damage due to poor water flowing and the blocked pipeline. Therefore, the above-mentioned mixing method of premixed fire extinguishing agent cannot be used in situations where large-scale delivery of the fire extinguishing agent is required.

In addition, in the fire extinguishing equipment in the prior art, mixing of a powdered fire extinguishing agent and a water flow usually adopts a scheme of an independent input pipeline plus an overlapping output pipeline. For example, Chinese patent CN201591928U discloses a pipe-in-pipe composite jet flow fire extinguishing cannon and as shown in FIG. 1, it uses separate inputs of various fire extinguishing agents, and different fire extinguishing agents are delivered through inner and outer pipes, so that a mixed liquid and ultrafine dry powders are not mixed with each other in the process of delivery, and only merged at the spray port, so their respective characteristics are completely retained and additionally, due to the wall attachment effect of direct-flow pressure water or foam mixture, the ultrafine dry powders with good hydrophobicity can be carried over a longer distance. Chinese patent CN207722267U discloses a fire extinguishing gun for adjusting a mixing ratio of water to ultrafine dry powder fire extinguishing agent, and as shown in FIG. 2, a front end of a gun body 8 is provided with a spray nozzle, and a rear end of the gun body 8 is provided with an independent powder inlet pipe and an independent water inlet pipe, where a front part of the powder inlet pipe is sleeved inside a front part of the water inlet pipe, a water passing cavity is left between the front part of the powder inlet pipe and the front part of the water inlet pipe, and a front end of the powder inlet pipe and a front end of the water inlet pipe are both connected with the spray nozzle.

These fire extinguishing water cannons or water guns are designed for dry powder fire extinguishing agents, and the dry powder fire extinguishing agents are usually insoluble in water and do not absorb water, and other fire extinguishing agents on the market do not have the situation of absorbing water and swelling and viscosity increasing. So this type of fire extinguishing water cannons has no problem when using the dry powder fire extinguishing agents or foam fire extinguishing agents. However, when a super absorbent resin is used as a fire extinguishing agent, serious problems will arise. The super absorbent resin is actually neither soluble in water nor hydrophobic, but can rapidly absorb water molecules into the polymer structure and is immobilized to form a gel. Therefore, as the water spraying and powder spraying are carried out at the same time, various water splashes and water droplets will be continuously sputtered on the pipeline. These water splashes and the powders sprayed from the powder spray port will be instantly adsorbed together, and more and more water-absorbing resin will be attached near the powder spray port, which will completely block the powder spray port after working for a period of time. And this problem will become more serious as performance indicators of the super absorbent resin are better. In the experiments conducted by our company, peripheral water flow will flow in or sputter or drip into the vicinity of an inner layer powder spray port through various ways. Due to high viscosity and very rapid solidification, the resin after absorbing water will gradually accumulate at the spray port to form a volcano-like resin pile, gradually compressing the powder spray channel, and finally completely closing the powder outlet. In the worst case, the solidified resin will directly block the pipeline inside the powder spray port in a very short time.

In view of this, there is a need for a fire extinguishing system in the market that can achieve rapid mixing of super absorbent resin powders and a water flow, and can continuously and stably deliver the mixed gel solution to a designated location.

### SUMMARY

The technical problem to be solved by the present disclosure is to provide a fire extinguishing system, which can achieve rapid mixing of super absorbent resin powders and a water flow, and can continuously and stably deliver the mixed gel solution to a designated location.

The technical solution of the present disclosure is to provide a mixed jet flow fire extinguishing system, including a water spray nozzle and a powder spray nozzle, where a water spray port of the water spray nozzle and a powder spray port of the powder spray nozzle do not overlap, and a powder spray direction A of the powder spray nozzle is inclined relative to a water flow spray direction B of the water spray nozzle.

The super absorbent resin powders sprayed from the powder spray nozzle is externally mixed in the air with the water flow sprayed from the water spray nozzle.

The super absorbent resin powders are sodium polyacrylate resin powders.

The water spray nozzle and the powder spray nozzle may be separately disposed or integrally disposed.

The powder spray nozzle is disposed above or on a side of the water spray nozzle.

A position of the powder spray port is behind a position of the water spray port.

The water spray nozzle is a part of a fire extinguishing water cannon, a fire extinguishing water hose or a fire extinguishing water gun, and is connected with a water spray pipe, and the water spray nozzle can spray a high-pressure water flow or a water mist.

The powder spray nozzle is connected with a powder spray pipe, the powder spray pipe is connected with a powder storage tank, and the powder storage tank is connected with a high-pressure air source.

The number of the powder spray nozzle is two or more.

In addition, the present disclosure further provides a mixing method of a super absorbent resin powder fire extinguishing agent and water, characterized in that spraying, by a water spray port of a water spray nozzle, a water flow, and spraying, by a powder spray port of a powder spray nozzle that does not overlap with the water spray port, super absorbent resin powders, where a spray direction A of the super absorbent resin powders intersects obliquely with a spray direction B of the water flow.

The super absorbent resin powders sprayed from the powder spray nozzle is externally mixed in the air with the water flow sprayed from the water spray nozzle.

The super absorbent resin powders are sodium polyacrylate resin powders.

The super absorbent resin powders are sprayed into the water flow from above, on a side of, or behind the water spray port of the water spray nozzle.

In the prior art, there are also fire extinguishing water cannons and water guns that use two independent spray pipes. For example, Chinese Patent CN 106730542 A discloses a pressurized fire extinguishing water gun, and as shown in FIG. 3, it consists of a fire extinguishing main pipe, an air gun pipe, a detachable air gun nozzle, a detachable water gun nozzle and a handle, a pressurized pipe is disposed between the fire extinguishing main pipe and the air gun pipe, the detachable water gun nozzle is installed at a front end of the fire extinguishing main pipe, the detachable air gun nozzle is installed at a front end of the air gun pipe, an inner side of the air gun pipe is connected to the fire extinguishing main pipe through the pressurized pipe. However, this kind of water gun is not designed for mixing a fire extinguishing agent and a water flow, and the air gun nozzle and water gun nozzle do not spray air and water flow at the same time, and only when the water flow is pressurized, the air gun pipe and the water gun pipe are communicated at the rear. For another example, Chinese Patent CN 204932678 U discloses an improved fire extinguishing device for asphalt production, and as shown in FIG. 4, it is provided with a vertical rotating pipe in an upper part including a main pipe, branch pipes are disposed at both ends of the rotating pipe, the branch pipes are communicated with the rotating pipe through a horizontal pipe, where one of the branch pipes extends a first launching pipe forward, rear parts of the two branch pipes are communicated with each other and are communicated with a water distribution pipe, and the water distribution pipe extends a second launching pipe forward. Although there are two independent spray pipes, the first and second launching pipes are not for mixing powders and water flow, and their functions are only that one can spray farther with a higher pressure, and the other can spray closer with a lower pressure, and they are usually not used together. For still another example, Chinese Patent CN 109893809 A discloses a multi-purpose fire extinguishing water gun for fire extinguishing, and as shown in FIG. 5, one side of a rubber sleeve is provided with a water gun spray port, and one side of the water gun spray port is provided with a foam spray port, and the other side of the water gun spray port is provided with a through pipe, a bottom side of a protective shell is provided with a rotating shaft, and one side of the rotating shaft is connected with a baffle plate, the baffle plate can be rotated by 45 degrees through the rotating shaft, and a length of the baffle plate is exactly a length of a diagonal line of the protective shell, and one side of the baffle plate is provided with an inlet, one side of the protective shell is provided with a connecting port, and the connecting port can be connected with an external fire extinguishing hose. Although this kind of water gun also has two independent spray pipes, its purpose is to separately spray different types of fire extinguishing agents, and it is realized by setting baffle plate, and does not relate to the mixing of powders and water flow. Therefore, none of the above-mentioned prior arts can realize the rapid mixing method of powders and water flow of the present disclosure, and it is even more impossible to achieve the technical effect of the present disclosure.

Compared with the prior art, the advantages of the present disclosure are as follows:

1. It has changed the way of using super absorbent resin as a fire extinguishing agent in the fire extinguishing field. From the existing premixing and then using, it turns into a spray-on-use mode, which greatly improves the fire extinguishing efficiency. At the same time, there is no need for additional mixing equipment, and the traditional water jet fire extinguishing method is not changed, and just a set of powder spray devices are added to the side of the water cannon to form a new fire extinguishing method in which powder is sprayed to the sprayed water jet, where the powders are carried by the water jet, the water is mixed with and absorbed by the powders while moving, and the full water absorbing and mixing is completed within a few seconds before reaching the fire site. When the water flow reaches the fire site, a fire extinguishing gel is also just formed, which does not affect the advantages of the existing rapid fire extinguishing response at all. In fact, this is also a unique fire extinguishing method for using super absorbent resin such as sodium polyacrylate as the fire extinguishing agent. For common dry powder fire extinguishing agents, when using the mixing method of the present disclosure, the mixing degree and the mixing effect cannot reach the technical effect of the present disclosure.

2. The idea that the fire extinguishing agent powders enter the water flow from the outside is creatively proposed, avoiding the blockage of the pipeline. In the past, since powdered fire extinguishing agents were usually light, the airflow environment of the fire site was complex, and the powders were usually blown out by compressed air and thus had a relatively large spreading area, so designers usually assume that if the powders are sprayed out with water all around, all the powders will hit the “water wall” directly, and there will be very little leakage of powders. At the same time, dry powder fire extinguishing agents are insoluble in water and require strong mixing of water flow and powders. Other types of powder fire extinguishing agents may be soluble in water. But no matter which kind of fire extinguishing agent is used, it will not cause blockage of the fire extinguishing pipeline immediately upon touching some water. Therefore, the prior art usually uses the method of placing the powder spray pipe within the water pipe, so that the powders and the water flow can be better mixed together, and the force of the water flow can be used to deliver the powder farther. However, when the super absorbent resin powders are used as a fire extinguishing agent, such a structure will allow the water flow of the outer layer to have too much opportunity to enter the powder spray port of the inner layer, causing blockage. Therefore, our company creatively proposed a technical solution of separating the powder spray nozzle from the water spray nozzle. In this solution, the powder spray nozzle is actually disposed above or on the side of the water spray nozzle in most cases, and after the water flow is sprayed in a straight line, there is substantially no chance for the water flow to enter an area near the powder spray port, which minimizes the possibility of the powder spray nozzle contacting with the water. Experiments have proved that the fire extinguishing system in this structure can work continuously for tens of minutes without blockage.

3. The mixing of the resin powders and the water flow is changed from mixing inside the spray port or at the outlet to mixing in the air at a certain distance from the spray port, so that a physical distance between the powder spray port and the water spray port is extended, which greatly reduces the opportunity of the water flow entering the area near the powder spray port. The physical property of super absorbent resin, especially sodium polyacrylate resin, is used to the maximum, and the high water absorption amount and high water absorption rate are no longer obstacles for use of sodium polyacrylate as a fire extinguishing agent, but an advantage. The resin powders and the water flow do not need to be mixed in any closed or semi-closed space, but are mixed directly in the air, which can greatly solve the impact of the high viscosity gel produced after water absorption on the spraying of the fire extinguishing agent.

4. The strong water flow or water mist sprayed in the middle can deliver the gel formed by the resin to a farther place, and when the high-pressure water flow is sprayed rapidly, a certain negative pressure is generated around it, and can absorb the sprayed resin powders floating with the air flow into the water flow. This makes good use of the characteristics of low density and small size of the resin powder. In practice, as long as the powder spray port is not too far away from the water jet, it is substantially guaranteed that at least 95% of the resin powder will be mixed with the sprayed water jet.

5. The powder spray nozzle and the water spray nozzle are each set independently, have a simple structure, and the two spray heads can be combined, by using a fixing device, into a whole by using a fixing device. The appearance is small and beautiful, the occupied space is small, the installation and disassembly are more convenient, the maintenance or the replacement of components is very simple and it is easy to operate. Under the integrated structure, the structure of the whole system is very simple, the appearance is beautiful, and it is not easy to, for example, change positions of the spray heads or damage them during the training, transporting and fire extinguishing process of the equipment.

6. For the manufacturer, in the pursuit of cost balance, there is no need to make any substantial change to the existing fire extinguishing water cannons, water guns or water hoses. To achieve the technical effect of the present disclosure, the original water spray nozzle can be used, and it only needs to further separately install a powder spray device, which greatly reduces the cost of transformation.

### BRIEF DESCRIPTION OF THE DRAWINGS

FIG. 1 is a structural schematic diagram of a multi-phase jet flow water cannon in the prior art;

FIG. 2 is a structural schematic diagram of a multi-phase jet flow water gun in the prior art;

FIG. 3 is a structural schematic diagram of a water cannon with multiple spray pipes separated in the prior art;

FIG. 4 is a structural schematic diagram of a water cannon with multiple spray pipes separated in the prior art;

FIG. 5 is a structural schematic diagram of a water gun with multiple spray pipes separated in the prior art;

FIG. 6 is a structural schematic diagram of an embodiment of a fire extinguishing system of the present disclosure;

FIG. 7 is a structural schematic diagram of another embodiment of a fire extinguishing system of the present disclosure;

FIG. 8 is a schematic diagram of a position of a spray port of another embodiment of a fire extinguishing system of the present disclosure; and

FIG. 9 is a schematic diagram of a position of a spray port of another embodiment of a fire extinguishing system of the present disclosure.

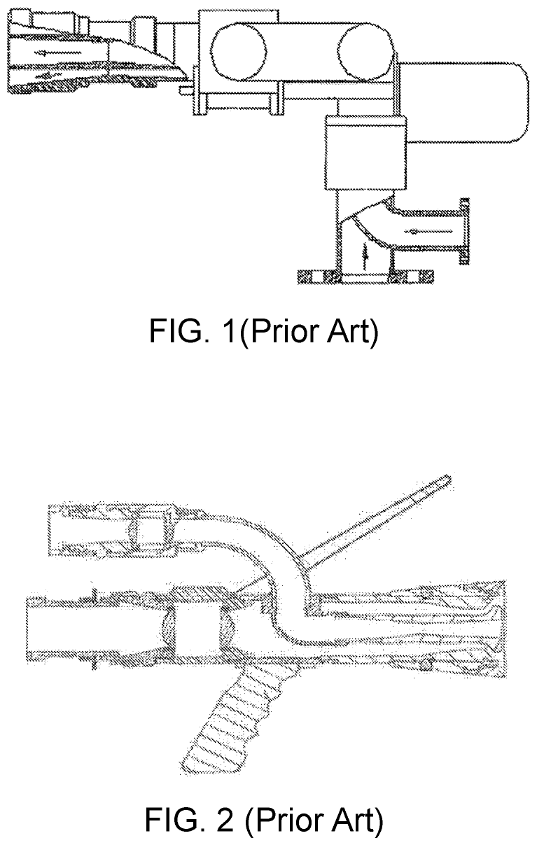

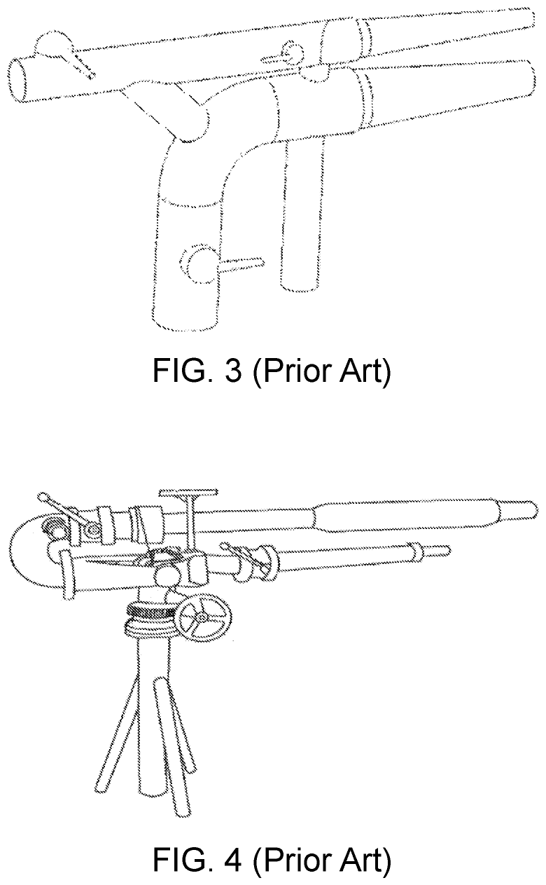

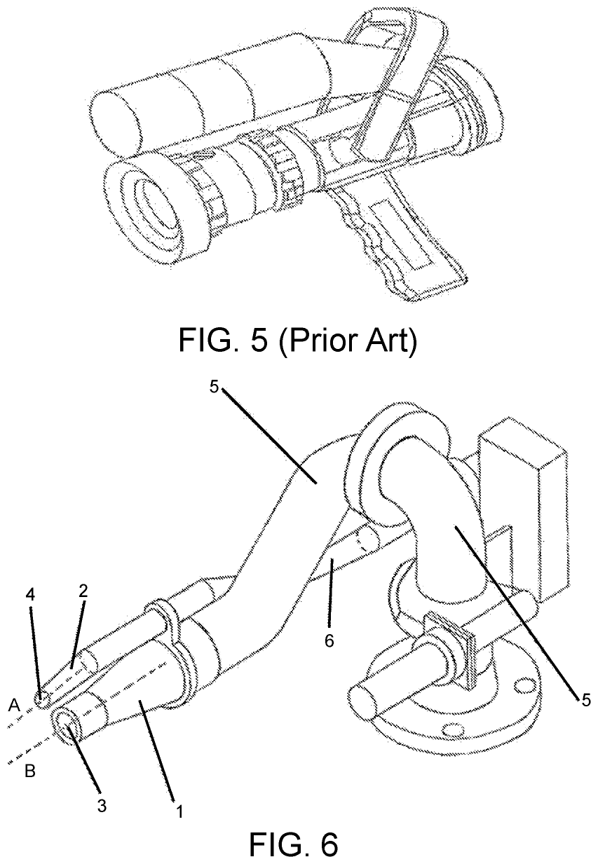

### DESCRIPTION OF THE EMBODIMENTS

The embodiments of the present disclosure are described in detail below. The following embodiments are implemented on the premise of the technical solution of the present disclosure, and give detailed implementation methods and specific operation procedures. However, the protection scope of the present disclosure is not limited to the following embodiments.

With reference to FIG. 6, the present disclosure relates to the technical field of fire extinguishing equipment, and discloses a mixed jet flow fire extinguishing system, including a water spray nozzle 1 and a powder spray nozzle 2, a water spray port 3 of the water spray nozzle 1 and a powder spray port 4 of the powder spray nozzle 2 do not overlap, a powder spray direction A of the powder spray nozzle 2 is inclined relative to a water flow spray direction B of the water spray nozzle 1, and super absorbent resin powders sprayed from the powder spray nozzle 2 is externally mixed in the air with a water flow sprayed from the water spray nozzle 1.

Generally speaking, a fire extinguishing system or a fire extinguishing device includes several components, such as water pump, high-pressure pump, pipeline, valve, water connection port, control device, etc. However, for the present disclosure, it only includes two core parts, i.e., a powder spray device and a water spray device. As long as the two devices are matched properly, the objective of the present disclosure can be achieved. Previous experiments of our company were mainly carried out around the modification of the mixed jet flow equipment in the prior art. Since the mixed jet flow equipment in which dry powder and high-pressure water jet are sprayed together to extinguish fire has already exist in the prior art, if similar equipment could be used directly, the development cost is omitted, and the experiment cost is very low. However, after a series of experiments and replacement of several types of super absorbent resins in the process, the spray effect could not be achieved well. The key problem is that the existing three-phase or two-phase mixed jet flow fire extinguishing equipment is in a structure where the water spray port and the powder spray port are nested with each other, water spraying and the powder spraying are carried out at the same time, and the water and the powders are wrapped around each other and sprayed out. Since the high-pressure water jet has a very high pressure, the collision between the water lines is relatively intense, and the splashed water is very easy to enter around the powder spray port. Additionally, compared with the existing powder fire extinguishing agents, the biggest difference of the super absorbent resin powders is that it is neither soluble in water nor hydrophobic, and after encountering water, they rapidly swell with the viscosity increasing rapidly to become gel-like, and gradually become solid gel to seal the inner wall surrounding the powder spray port 4 and eventually completely close the powder spray port, resulting in that the resin as the fire extinguishing agent cannot be sprayed out.

For this problem, we creatively set the powder spray nozzle 2 independently outside of the water spray nozzle 1, and two spray ports of the nozzles do not overlap and are separated by a certain distance. The super absorbent resin powders, especially sodium polyacrylate resin powders, can be directly sprayed to the high-pressure water jet from the outside, and can be rapidly added into the water flow and fly to the fire site with the water flow together due to excellent water absorption rate of sodium polyacrylate resin powders. The resin powders will not be scattered around under the strong negative pressure of the high-pressure water jet, which can well deal with the problem of unstable air flow in the fire site. If only from the perspective of mixing of two substances, the mixing effect of the fire extinguishing system of the present disclosure is not necessarily better than that of the existing pipe-in-pipe type mixed jet flow system, but the present disclosure solves the problem existed when the mixed water cannon uses new fire extinguishing agent powder in the prior art, and achieves an excellent technical effect when using the super absorbent resin powders, especially sodium polyacrylate resin powders, as a fire extinguishing agent, giving a full play of characteristics of sodium polyacrylate resin powders. Even if the mixing is not very well at the beginning, during the process of the water jet reaching the fire site, sodium polyacrylate will still absorb a large amount of water molecules of the water jet, and will continue to absorb water molecules after being attached to a fire object, until it absorbs 300-500 or more times its volume.

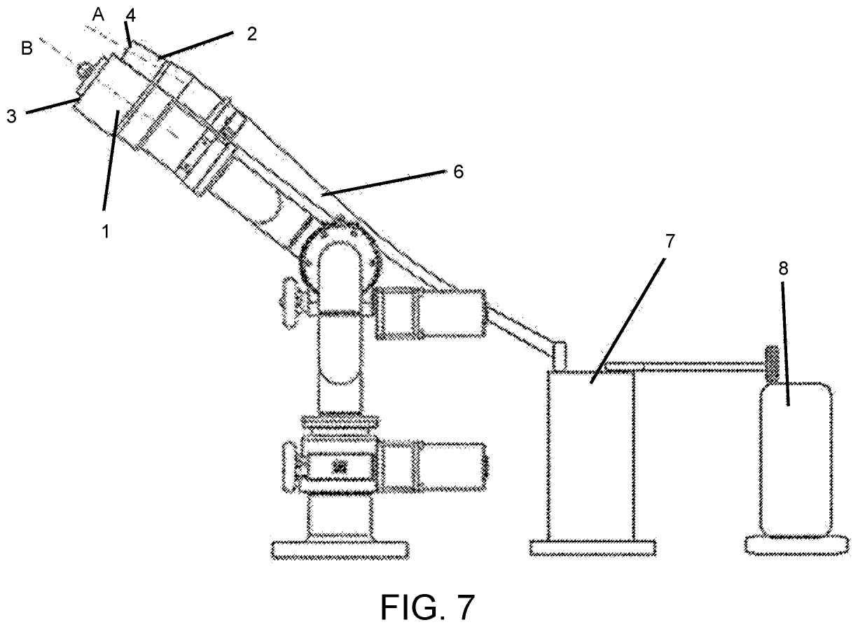

A powder spray direction A of the powder spray nozzle 2 is inclined relative to a water flow spray direction B of the water spray nozzle 1. Herein, the term “spray direction” refers to a direction in which the super absorbent resin powders are sprayed out at the powder spray port and a direction in which the water flow is sprayed out at the water spray port. That is, the direction in which the powders are actually sprayed out and the direction in which the water flow is actually sprayed out should be intersecting. Otherwise, the powders will inevitably produce some unnecessary loss when the powders are under the action of pressurized air. The actual shapes and travelling paths of the powder spray pipe and the water spray pipe before spraying are not our main concerns. Theoretically, the actual spray directions of the powders and the water flow are relatively easy to determine from the shape and structure of the device. For example, referring to FIG. 6 and FIG. 7, it is very easy to see from the appearance and shape that the water spray nozzle 2 is inclined relative to the water spray nozzle 1, and if the internal structure is a normal symmetrical design, the spray direction of the powders and the water flow can be determined. The design of the present disclosure is actually to allow the resin powders sprayed from the powder spray port 4 to be obliquely sprayed from a side or behind to the side of the high-pressure water jet, so that the floating powders can be attracted, by the negative pressure generated by the high-pressure water jet, to the liquid surface of the water jet to the maximum extent. In some cases, the shape of the powder spray nozzle 2 may not be very irregular, but this does not affect the spraying of the powders along its axial direction, and it is possible to ensure as far as possible that the shape of the powder spray channel formed inside the powder spray nozzle 2 is completely symmetrical, and thus the spray direction is relatively easy to determine. Even if the shape of the spray port or the shape of the spray pipe is not symmetrical in some cases, there should also be such a powder spray direction A, which can indicate the direction of spraying of the powders.

Preferably, the super absorbent resin powders are sodium polyacrylate resin powders. According to the experiments of our company, not all super absorbent resin powders can achieve the optimal fire extinguishing effect. The effects of water absorption, mixing and state transition between various super absorbent resin powders are significantly different, and when the super absorbent resin powders after absorbing water are sprayed to the fire site, the fire extinguishing effect is different. The indicators such as water absorption rate, water absorption multiple, viscosity, and density of sodium polyacrylate resin powders are in good agreement with the fire extinguishing system and the mixing method of the present disclosure, thereby achieving excellent fire extinguishing effect.

The water spray nozzle 1 and the powder spray nozzle 2 may be disposed independently in a split mode or disposed in an integrated mode. Referring to FIG. 6 and FIG. 7, the water spray nozzle 1 and the powder spray nozzle 2 generally refer to a part of the water spray device close to the water spray port 3 and a part of the powder spray device close to the powder spray port 4. In the split mode, the powder spray nozzle 2 is independently disposed outside the water spray nozzle 1, and there is a buffer space between spray ports of the two nozzles, which can prevent most of the splashed water drops from being sprayed to the powder spray port, solving the problem of gel blocking the powder spray port. And this separated-type structure is simple to manufacture, simple to maintain, and simpler to replace a component.

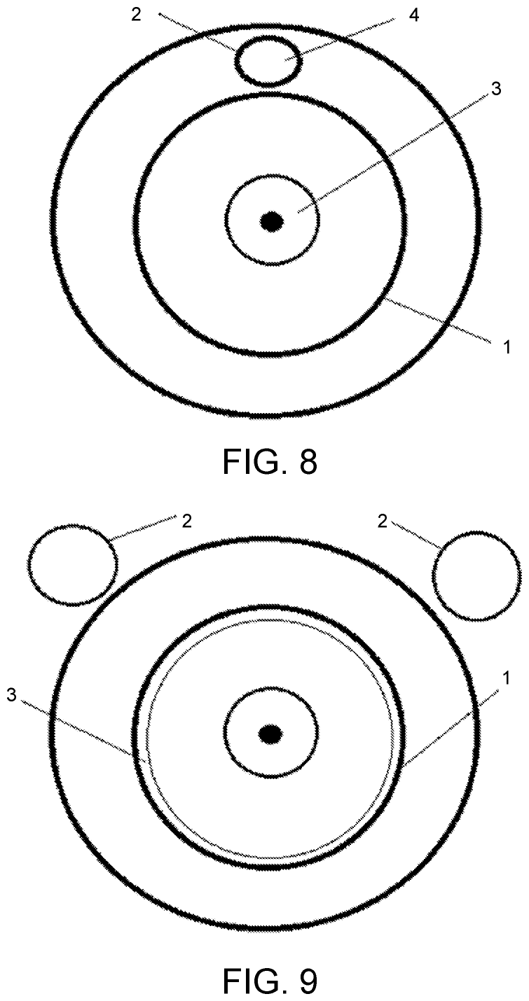

Referring to FIG. 8, in the integrated mode, through a reasonable design, the water spray port and the powder spray port may still be separated by a certain distance and the volume is reduced, and at the same time, the structure of the whole system is very simple, and the appearance is beautiful. It is not easy to, for example, change positions of the spray heads or damage them during training, transporting and fire extinguishing process of the equipment.

Referring to FIGS. 6-9, the powder spray nozzle 2 is disposed above or on a side of the water spray nozzle 1. The super absorbent resin powders are sprayed into the water flow from above and a side of the water spray port 3 of the water spray nozzle 1. This design mainly takes an actual working process of the high-pressure water cannon into account, where the angle of use of the water cannon is generally obliquely upward, and upon the high-pressure water cannon opens a valve, there is a process of opening the valve and there is no residual water in the pipeline. So it will cause the high-pressure water jet to not be formed instantaneously at the beginning, but from weak to strong. This process usually causes the water flow in the water cannon to flow directly to be under the water spray nozzle 1. In addition, when the high-pressure water cannon just finishes spraying, the valve needs to be closed gradually. During closing process of the valve, the pressure and the water volume in the pipeline gradually decrease until the finally sprayed water jet falls directly due to insufficient pressure, which will cause this part of the water flow to drop directly to be under the water spray nozzle 1. If the powder spray port 2 is disposed below, it is easy to cause the blockage of the powder spray port 2.

Referring to FIG. 7, the position of the powder spray port 4 is behind the position of the water spray port 3. The super absorbent resin powders are sprayed into the water flow from behind the water spray port 3 of the water spray nozzle 1. This design can effectively lengthen the distance between the powder spray port 4 and the water spray port 3, and set the easily blocked powder spray port in a place where water droplets cannot be splashed, substantially eliminating the problem of the blockage of the powder spray port 4. The reason why this design can be realized mainly lies in that the powder spraying itself has a certain pressure, which can ensure that the powders do not cause large-scale dispersion in a short distance. The second reason is that the resin powders with light density may be attracted well under the strong negative pressure of the high-pressure water jet. In this way, the advantages of the external powder-internal water mode and the sodium polyacrylate resin powders can be fully utilized, and the shortcoming of easy blockage of the outlet can be avoided.

The water spray nozzle 1 is a part of a fire extinguishing water cannon, a fire extinguishing water hose or a fire extinguishing water gun, and is connected with a water spray pipe 5, to spray high-pressure water flow or water mist. Referring to FIGS. 6 and 7, it can be seen that the fire extinguishing system of the present disclosure may actually be obtained from modification of most existing fire extinguishing devices. No matter what kind of water cannon or water gun is originally, a separate powder spray pipe may be added, thereby getting the fire extinguishing system of the present patent. This is also a major contribution of the present disclosure. It is not simply putting two existing equipment together, but according to the characteristics of the fire extinguishing agent, an optimally combined configuration method is selected in the existing fire extinguishing devices, where the powder spray device is separated from the pipe-in-pipe type mixed jet flow equipment and disposed in an optimal position, so that when the sodium polyacrylate resin powders are used as a fire extinguishing agent, they can exert their maximum efficacy and minimize the cost of the whole system.

Referring to FIG. 7, the powder spray nozzle 2 is connected with a powder spray pipe 6, the powder spray pipe 6 is connected with a powder storage tank 7, and the powder storage tank 7 is connected with a high-pressure air source 8. This is also a configuration of a conventional powder spray device of mixed jet flow equipment, but the present disclosure can set this part independently outside the water spray device. The existing pipe-in-pipe type mixed jet flow equipment has a complicated structure and troublesome maintenance and disassembly. Of course, directly connecting with other type of powder supply device does not affect the effect of the present disclosure, the core of which is still that the fire extinguishing agent sprayed by the powder spray device may be sprayed to the water jet.

Referring to FIG. 9, the number of the powder spray nozzle 2 is two or more. On one hand, it can increase the amount of fire extinguishing resin powders sprayed per unit time, and it can also spray the resin powders into the water flow more uniformly. When using certain types of super absorbent resin powders, such as those with a slower water absorption rate, the fire extinguishing effect may be improved.

In addition, the present disclosure further provides a mixing method of a super absorbent resin powder fire extinguishing agent and water, where spraying, by a water spray port of a water spray nozzle, the water flow, and spraying, by a powder spray port of a powder spray nozzle that does not overlap with the water spray port, super absorbent resin powders, where a spray direction of the super absorbent resin powder obliquely intersects with a spray direction of the water flow.

What is embodied herein is the revolutionary advantage of the present disclosure over the prior art in mixing method. There is no document in the prior art that mentions this use method of the super absorbent resin powder fire extinguishing agent. The present disclosure abandons the existing use method in which the super absorbent resin needs to be premixed, but directly mixes the two substances in the air, which is equivalent to that the powders are directly hit into the water jet in the air. The super-fast water absorption rate of the sodium polyacrylate powders is fully utilized, and the premixing procedure is omitted. The spraying speed of the high-pressure water jet in the fire extinguishing water cannon is the casting speed of the fire extinguishing agent. The whole mixing process is fast and continuous, abandoning the traditional design thinking of spraying together with the water wrapping the powders in the prior art. By the design of intersecting negative pressure direction and spray direction, a technical solution of the powder hitting water and spraying together is creatively adopted, without powder floating around. In addition, the water spray port and the powder spray port are separated by a certain distance, so that the impact of the splashed water on the powder spray port is reduced to a very low level, the fire extinguishing effect is good and the blockage will not occur.

Preferably, the super absorbent resin powders are sodium polyacrylate resin powders. The super absorbent resin powder sprayed from the powder spray nozzle is externally mixed in the air with the water flow sprayed from the water spray nozzle. The super absorbent resin powders are sprayed into the water flow from above, on a side of, or behind the water spray port of the water spray nozzle. The above-mentioned preferred solution can fully utilize the advantages of the mixing method of external powder-internal water, so that the spraying and mixing are safer without blockage.

The advantage of the present embodiment is that the technical bottleneck of using sodium polyacrylate resin powders as a fire extinguishing agent in the prior art is solved, so that the sodium polyacrylate resin powders can be smoothly and continuously sprayed into a fire site, without blocking the powder spray port.

The above descriptions are only the preferred embodiments of the present disclosure and are not used to limit the present disclosure. Any modification, equivalent replacement and improvement made within the spirit and the principle of the present disclosure shall be included in the protection scope of the present disclosure.

1. A mixed jet flow fire extinguishing system, comprising a water spray nozzle and a powder spray nozzle, wherein a water spray port of the water spray nozzle and a powder spray port of the powder spray nozzle do not overlap, and a powder spray direction of the powder spray nozzle is inclined relative to a water flow spray direction of the water spray nozzle.

2. The fire extinguishing system according to claim 1, wherein super absorbent resin powders sprayed from the powder spray nozzle is externally mixed in an air with a water flow sprayed from the water spray nozzle.

3. The fire extinguishing system according to claim 2, wherein the super absorbent resin powders are sodium polyacrylate resin powders.

4. The fire extinguishing system according to claim 1, wherein the water spray nozzle and the powder spray nozzle are separately disposed or integrally disposed.

5. The fire extinguishing system according to claim 1, wherein the powder spray nozzle is disposed above or on a side of the water spray nozzle.

6. The fire extinguishing system according to claim 1, wherein a position of the powder spray port is behind a position of the water spray port.

7. The fire extinguishing system according to claim 1, wherein the water spray nozzle is a part of a fire extinguishing water cannon, a fire extinguishing water hose or a fire extinguishing water gun, is connected with a water spray pipe, and is capable of spraying a high-pressure water flow or a water mist.

8. The fire extinguishing system according to claim 1, wherein the powder spray nozzle is connected with a powder spray pipe, the powder spray pipe is connected with a powder storage tank, and the powder storage tank is connected with a high-pressure air source.

9. The fire extinguishing system according to claim 1, wherein a number of the powder spray nozzle is two or more.

10. A mixing method of a super absorbent resin powder fire extinguishing agent and water, the mixing method comprising spraying, by a water spray port of a water spray nozzle, a water flow, and spraying, by a powder spray port of a powder spray nozzle that does not overlap with the water spray port, super absorbent resin powders, wherein a spray direction of the super absorbent resin powders obliquely intersects with a spray direction of the water flow.

11. The mixing method according to claim 10, wherein the super absorbent resin powders sprayed from the powder spray nozzle are externally mixed in an air with the water flow sprayed from the water spray nozzle.

12. The mixing method according to claim 10, wherein the super absorbent resin powders are sodium polyacrylate resin powders.

13. The mixing method according to claim 10, wherein the super absorbent resin powders are sprayed into the water flow from above, on a side of, or behind the water spray port of the water spray nozzle.
